(19) United States
(12) Patent Application Publication
(10) Pub. No.: US 2016/0011543 A1
(43) Pub. Date: Jan. 14, 2016

(54) METHOD OF MAKING TOS FUSER ROLLS AND BELTS USING PHOTONIC SINTERING TO CURE TEFLON TOPCOATS

(71) Applicant: XEROX CORPORATION, Norwalk, CT (US)

(72) Inventors: Yu Qi, Penfield, NY (US); Mandakini Kanungo, Penfield, NY (US); Phillip J. Wantuck, San Jose, CA (US); David J. Gervasi, Pittsford, NY (US); Santokh S. Badesha, Pittsford, NY (US)

(21) Appl. No.: 14/687,631

(22) Filed: Apr. 15, 2015

Related U.S. Application Data
(60) Provisional application No. 62/024,161, filed on Jul. 14, 2014.

(51) Int. Cl. C08J 7/18; G03G 15/20

(52) U.S. Cl. CPC G03G 15/206

(57) ABSTRACT

Provided is a method of making fuser members. The method can include applying a rubber conformance layer over a substrate, applying a suspension composition over the conformance layer, the suspension composition comprising a plurality of fluoroplastic particles over the conformance layer, and exposing the plurality of fluoroplastic particles to pulsed light to form a continuous topcoat film.

### CROSS-REFERENCE TO RELATED APPLICATIONS

This application claims priority to U.S. Provisional Patent Application Ser. No. 62/024,161, filed on Jul. 14, 2014, the entirety of which is incorporated herein by reference.

### FIELD

This disclosure is generally directed to fuser members useful in electrophotographic imaging apparatuses, including digital, image on image, and the like. This disclosure also relates to processes for making and using fuser members.

### BACKGROUND

In electrophotography (also known as xerography, electrophotographic imaging or electrostatographic imaging), the surface of an imaging member (e.g., photoreceptor) is first uniformly electrostatically charged. The imaging member contains a photoconductive insulating layer on a conductive layer and is then exposed to a pattern of activating electromagnetic radiation, such as a light. Charge generated by the photoactive pigment moves under the force of the applied field. The movement of the charge through the photoreceptor selectively dissipates the charge on the illuminated areas of the photoconductive insulating layer while leaving behind an electrostatic latent image. This electrostatic latent image is then developed to form a visible image by depositing oppositely charged particles on the surface of the photoconductive insulating layer.

The resulting visible image is then transferred from the imaging member directly or indirectly (such as by a transfer or other member) to a print substrate, such as a transparency or paper sheet. The imaging process may be repeated many times with reusable imaging members. The visible toner image is therefore transferred on the print substrate and is usually fixed or fused to form permanent images since the visible toner image is in a loose powdered form and can be easily disturbed or destroyed. The use of thermal energy for fixing toner images onto a support member is well known. In order to fuse electroscopic toner material onto a support surface permanently by heat, it is necessary to elevate the temperature of the toner material to a point at which the constituents of the toner material coalesce and become tacky. This heating causes the toner to flow to some extent into the fibers or pores of the support member. Thereafter, as the toner material cools, solidification of the toner material causes the toner material to be firmly bonded to the support.

Several approaches to thermal fusing of electroscopic toner images have been described in the prior art. These methods include providing the application of heat and pressure substantially concurrently by various means: a roll pair maintained in pressure contact; a belt member in pressure contact with a roll; and the like. Heat may be applied by heating one or both of the rolls, plate members or belt members. The fusing of the toner particles takes place when the proper combination of heat, pressure and contact time is provided. The balancing of these parameters to bring about the fusing of the toner particles is well known in the art, and they can be adjusted to suit particular machines or process conditions.

Fuser and fixing rolls or belts may be prepared by applying one or more layers to a suitable substrate. Typically, fuser and fixing rolls or belts include a surface layer for good toner releasing. Cylindrical fuser and fixer rolls may be prepared by applying a silicone elastomer or fluoroelastomer to serve as a release layer (also known as a fuser topcoat, or topcoat layer). Known fuser surface coatings also include crosslinked fluoropolymers such as VITON-GF®(DuPont) used in conjunction with a release fluid. Another type of surface layer materials includes fluororesin such as polytetrafluoroethylene (PTFE), perfluoroalkylvinylether copolymer (PFA) and the like. One known PTFE-based formula is available from DuPont having brand name, TEFLON® and can include both PTFE and PFA. As used herein, the term “Teflon” refers to materials having compositions that include PTFE and/or PFA and may include the DuPont brand of PTFE-based formulas sold under the TEFLON® brand. These types of materials are desired for oil-less fusing, namely, no release fluid being required. Specifically, a Teflon surface release layer enables oil-less fusing and the silicone layer provides conformability which enables rough paper fix, low mottle and good uniformity. Problems arise, however, due to insufficient mechanical robustness of the Teflon surface coatings, e.g., cracking and abrasion, which results in short operating life of the fuser. In addition, there is a need for electrical conductivity to dissipate the electrostatic built up during fusing process.

In some cases, fuser and fixing rolls or belts may include a metal core substrate, a resilient silicone rubber layer, and a surface release layer made of fluoroplastics, e.g., Teflon. Such combination of resilient layer and surface release layer may be referred to as Teflon-on-silicon, or TOS type fuser. A coating defect of fluoroplastics topcoats, e.g., cracks and bubbles, is a common issue related to the TOS fuser fabrication. This is due to high baking temperatures (i.e., over 300° C.) required for melting highly crystalline fluoroplastics, which are above the silicone degradation temperature (i.e., 250° C.). As PFA melts to form the topcoat, silicone rubber releases the degraded gas or small molecules. As a result, cracks or bubbles are formed on the topcoat layer. To tackle this issue, material and process solutions have been developed previously, e.g., CNT composite PFA topcoat, FKM primer layer, powder coating with large PFA particles and thin PFA topcoats. However, the fabrication latitude is still narrow for TOS fuser manufacture. For example, various fluoroplastics coating formulations developed by vendors such as DuPont only allow very narrow processing window to achieve defect-free PFA topcoat. PTFE as melting at a higher temperature (>330° C.) is not feasible for TOS fuser topcoat layers.

Accordingly, new fuser rolls and methods of manufacturing fuser member that overcome the challenges associated with conventional fuser member manufacturing are needed.

### SUMMARY

In an embodiment, there is a method of making fuser members. The method can include applying a rubber conformance layer over a substrate, applying a suspension composition over the rubber conformance layer, the suspension composition comprising a plurality of fluoroplastic particles, and exposing the plurality of fluoroplastic particles to pulsed light to form a continuous topcoat film.

In another embodiment there is a fuser member. The fuser member can include a substrate, a continuous topcoat film, a silicone rubber layer disposed between the substrate and the continuous topcoat film, and a primer layer disposed between the rubber layer and the continuous topcoat film. The continuous topcoat film can be a cured fluoroplastic formed from photosintered nanoparticles.

Advantages of at least one embodiment include fabrication methods for forming fuser members that require reduced energy/power consumption, provide improved throughput and quality, or result in decreased greenhouse gas emissions.

Additional advantages of the embodiments will be set forth in part in the description which follows, and in part will be understood from the description, or may be learned by practice of the embodiments. The advantages will be realized and attained by means of the elements and combinations particularly pointed out in the appended claims.

It is to be understood that both the foregoing general description and the following detailed description are exemplary and explanatory only and are not restrictive of the embodiments, as claimed.

The accompanying drawings, which are incorporated in and constitute a part of this specification, illustrate embodiments and together with the description, serve to explain the principles of the embodiments.

### BRIEF DESCRIPTION OF THE DRAWINGS

FIG. 1A illustrates fusing system that includes a fusing member.

FIG. 1B illustrates a schematic view of a fusing member performing and a fusing process, according to an embodiment of the present disclosure.

FIGS. 2A-2B are images showing resulting cracks (FIG. 2A) and bubbles (FIG. 2B) in a topcoat layer formed according to a conventional method.

FIG. 3 is a flow chart depicting a method of making fuser members according to an embodiment.

FIGS. 4A-4B depict exemplary coated articles having an exemplary core substrate in accordance with the present teachings.

FIGS. 5A-5B are micrographs of the PTFE nanoparticles on a silicone substrate before (FIG. 5A) and after (FIG. 5B) photonic sintering.

FIGS. 6A-6C are micrographs of PTFE nanoparticles on a polyimide substrate before (FIG. 6A) and after (FIG. 6B) sintering, with a side-by-side comparison (FIG. 6C) between the sintered and unsintered regions adjacent to one another on the polyimide substrate.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3,−10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present embodiments. It is intended that the specification and examples be considered as examples only. The various embodiments are not necessarily mutually exclusive, as some embodiments can be combined with one or more other embodiments to form new embodiments.

For purposes of this application, the term “dispersion” refers to any system that include one substance being in another, e.g., one substance dissolving in another, or particles or other substance suspending or scattering in a fluid. Thus, the term “dispersion” can also be referred to herein as “solution”, “suspension”, “latex” or “emulsion”.

Embodiments described herein include a method to fabricate TOS fuser rolls and fuser belts using photonic sintering to cure PFA or PTFE, for example, PFA or PTFE particles formed over a resilient silicone layer. The topcoat can be cured very rapidly with pulsed light from a flash lamp to mitigate the formation of crack and bubble defects. The photonic sintering produces high energy pulsed light which has a very short duration, e.g., a few μs (microseconds) to few ms (milliseconds), which allows to sufficiently melt PFA or PTFE particles, such as nanoparticles, so as to form a continuous film at relatively low temperature, at which the silicone degradation described above is mitigated. Therefore, the photonic sintering process provides benefits such as widening process latitude, and improves productivity in TOS fuser manufacturing.

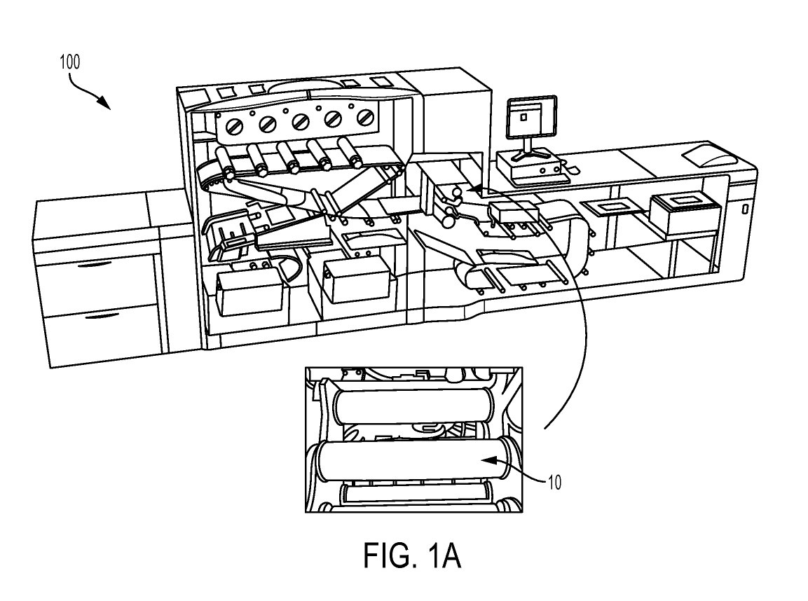

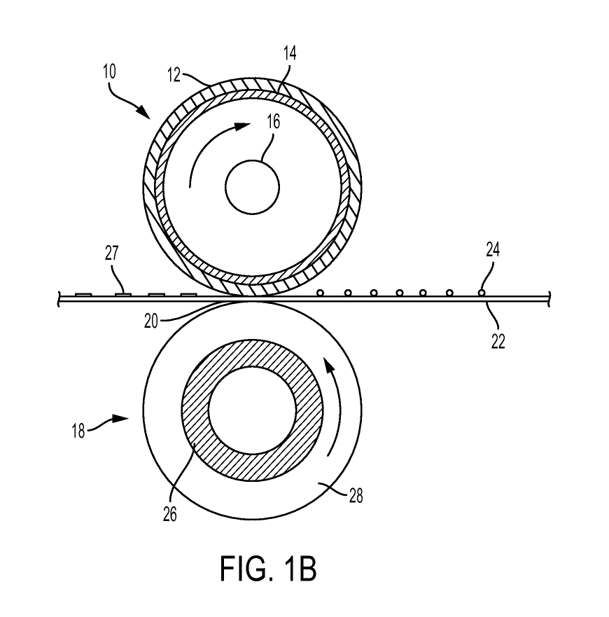

An example fuser member, such as fuser roll 10, is described in conjunction with a fuser system 100 as shown in FIGS. 1A-1B. Fuser roll 10 may include an outer layer 12, such as a topcoat layer, upon a suitable substrate 14, such as a fuser core. The substrate 14 can be a hollow cylinder or core fabricated from any suitable metal such as aluminum, anodized aluminum, steel, nickel, copper, and the like. Alternatively, the substrate 14 can be a hollow cylinder or core fabricated from non-metallic materials, such as polymers. Example polymeric materials include polyamide, polyimide, polyether ether ketone (PEEK), Teflon/PFA, silicone rubber and the like, and mixtures thereof, which can be optionally filled with fiber such as glass, and the like. In an embodiment, the polymeric or other core material may be formulated to include carbon nanotubes. Such core layers can further increase the overall thermal conductivity of the fuser member. In an embodiment, the substrate 14 can be in the form of an endless belt (not shown) of similar construction, as is well known in the art.

The substrate 14 can include a suitable heating element 16 disposed in the hollow portion thereof, according to an embodiment of the present disclosure. Any suitable heating element can be employed. Suitable heating elements are well known in the art.

Backup or pressure roll 18 cooperates with the fuser roll 10 to form a nip or contact arc 20 through which a copy paper or other print substrate 22 passes. Discrete, loose toner forming toner images 24 on the copy paper or other print substrate 22 contact the outer layer 12 of fuser roll 10 and are fused and adhered to the substrate, and form fused, adhered toner 27. As shown in FIG. 1B, the backup roll 18 can include a rigid steel core 26 with a soft surface layer 28 thereon, although the assembly is not limited thereto.

The design illustrated in FIGS. 1A-1B is not intended to limit the present disclosure. For example, other well known and after developed electrostatographic printing apparatuses can also accommodate and use the fuser members, sometimes referred to in the art as fixer members, described herein. For example, the depicted cylindrical fuser roll can be replaced by an endless belt fuser member (i.e., a fuser belt). In still other embodiments, the heating of the fuser member can be by methods other than a heating element disposed in the hollow portion thereof. For example, heating can be by an external heating element or an integral heating element, as desired. Other changes and modifications will be apparent to those in the art.

As used herein, the “fuser” may be in the form of a roll, belt such as an endless belt, flat surface such as a sheet or plate, or other suitable shape used in the fixing of thermoplastic toner images to a suitable substrate.

In an embodiment, the outer layer 12 is a topcoat/release layer and may include a continuous film formed of sintered particles, such as according to the photonic sintering method 300 described below, and may have a thickness of about 5 microns to about 50 microns. In an embodiment, there may be one or more intermediate layers between the substrate 14 and the outer layer 12. Typical materials having the appropriate thermal and mechanical properties for such intermediate layers include silicone rubber layer formed of silicon elastomers.

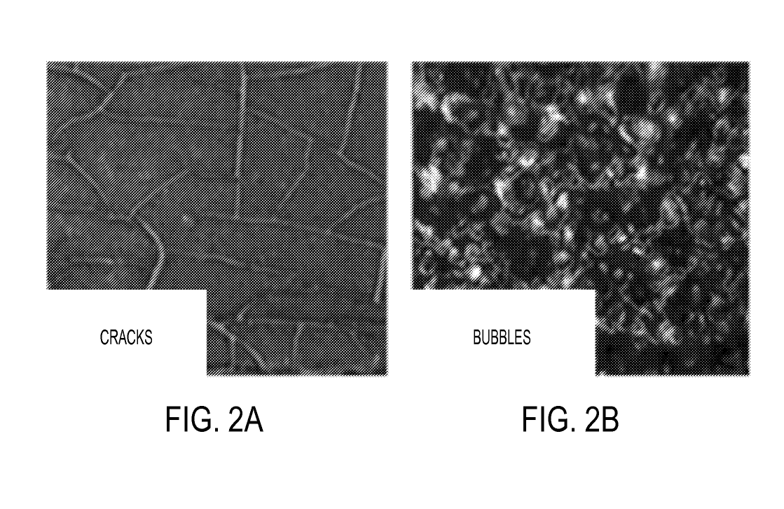

As described above, fluoroplastics have been used as the topcoat materials in TOS fusers for oil-less fusing owing to their good releasing property. PFA and PTFE, the most representative fluoroplastics for fusing applications, promise chemical and thermal stability, low surface energy. However, these materials are also highly crystalline and therefore difficult to be processed. High temperature sintering (>350° C.) is the only way by far to make them a continuous film. For a TOS fuser, the silicone rubber layer starts to degrade around 250° C. While melting the topcoats over 300° C., the silicone rubber releases the degraded gas or small molecules. This results in defects to the topcoat layer such as cracks (FIG. 2A) or bubbles (FIG. 2B).

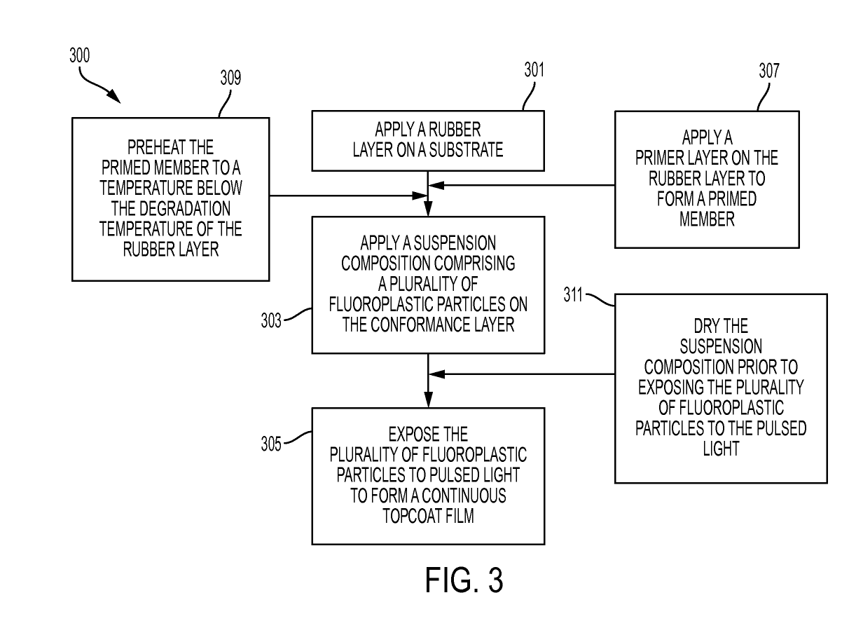

Accordingly, in an embodiment there is a method 300, as shown in FIG. 3, for making fuser members. The method can include the step 301 of applying a rubber layer over a substrate, step 302 of applying a suspension composition comprising a plurality of fluoroplastic particles over the conformance layer, and step 305 of exposing the plurality of fluoroplastic particles to pulsed light to form a continuous topcoat film.

In the step 305, the step of exposing to pulsed light can be photonic sintering to cure the plurality of fluoroplastic. For example, the pulsed light can be pulsed light from a xenon lamp and the fluoroplastic particles are exposed to the pulses of the light lasting about 1 millisecond to about 2 milliseconds. The pulsed light may be provided in pulses lasting about 1500 μs. Accordingly, in an example, the pulsed light sufficiently melts the plurality of fluoroplastic particles. In other words, while not limited to any particular theory, it is believed that the pulsed light heats the plurality of fluoroplastic particles to a temperature of equal to or greater than a melting temperature of the fluoroplastic and lower than a degradation temperature of the rubber layer, which avoids issues related to degrading silicon as described above with respect to topcoats formed according to conventional methods. In an example, the continuous topcoat film is formed in about 1 minute or less (in the range of microseconds to milliseconds). The pulsed light can include from 1 to 20 pulses. As described above, the plurality of fluoroplastic particles can comprise particles having particle sizes of about 100 nm to about 20 μm.

The fluoroplastic particles can include a plurality of fluoroplastic nanoparticles. For example, the fluoroplastic particles can include polytetrafluoroethylene (PTFE) nanoparticles and/or perfluoroalkoxy polymer resin (PFA) nanoparticles. As described above, the substrate can be formed of a metal and the rubber layer can include silicone rubber.

The topcoat film may further include a filler. For example, the suspension composition may further include a filler. Fillers can often be used in polymer formulations as reinforcing particles to improve the hardness and wear resistance. In various embodiments, fillers, such as carbon black, graphite, graphene, carbon nanotube and inorganic particles, can be used to form the suspension composition along with the fluoroplastic particles. For example, the inorganic particles can be dispersed in a media, such as water, to form a filler suspension. In an exemplary embodiment, the filler suspension can be prepared by sonication of inorganic particles in the presents of surface treatment agents such as silanes in water.

In various embodiments, the inorganic particles can include, but are not limited to, metal oxides, non-metal oxides, metals, or other suitable particles. Specifically, the metal oxides can include, for example, silicon oxide, aluminum oxide, chromium oxide, zirconium oxide, zinc oxide, tin oxide, iron oxide, magnesium oxide, manganese oxide, nickel oxide, copper oxide, antimony pentoxide, indium tin oxide, and mixtures thereof. The non-metal oxides can include, for example, boron nitride, silicon carbides (SiC) and the like. The metals can include, for example, nickel, copper, silver, gold, zinc, iron and the like. In various embodiments, other additives known to one of ordinary skill in the art can also be included in the nanotube coating composition. The filler suspension can then be added to a fluoroplastic particle suspension to form the suspension described in step 303 above.

The method may further include the step 307 of applying a primer layer over the rubber layer to form a primed member, wherein the primer layer is disposed between the rubber layer and the topcoat film, and wherein the primer layer comprises a thickness of about 3 m to about 5 m. The primer layer may be applied by spray coating. The method 300 may further include the step 309 of preheating the primed member to a temperature below the degradation temperature of the rubber layer. The method 300 may be repeated to produce greater than 200 members per hour.

The method may further include the step 311 of sufficiently drying the suspension composition prior to exposing the plurality of fluoroplastic particles to the pulsed light.

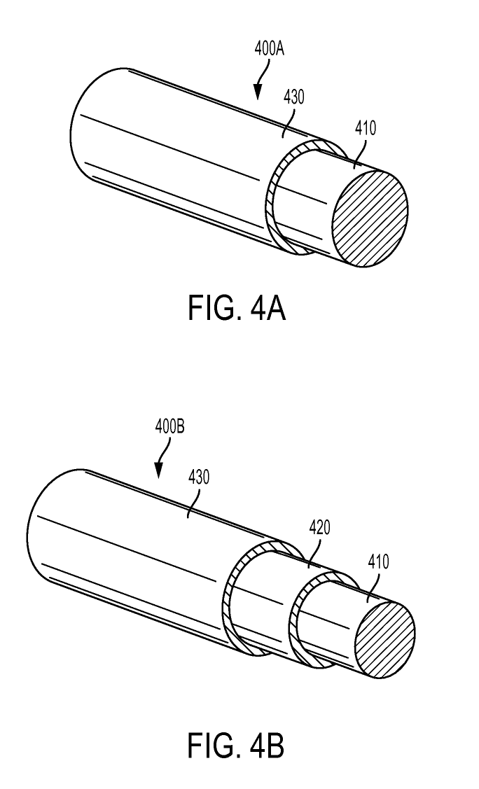

FIGS. 4A-4B depict exemplary coated articles 400A-B having an exemplary core substrate 410 in accordance with the present teachings. It should be readily apparent to one of ordinary skill in the art that the devices 400A-B depicted in FIGS. 4A-4B, respectively, represent generalized schematic illustrations and that other layers/substrates can be added or existing layers/substrates can be removed or modified. The coated articles 400 A-B can be fuser rollers for use as fuser roll 10 of FIG. 1B, and may include one or more functional layers such as compliant layer 420 and/or outermost layer 430 formed over the core substrate 410. In various embodiments, the core substrate 410 can take the form of a cylindrical tube or a solid cylindrical shaft and may be formed of one or more of the materials described for substrate 14 in FIG. 1B.

One of ordinary skill in the art will understand that other substrate forms, e.g., a belt substrate, can be used to maintain rigidity, structural integrity of the coated article. As shown, the outermost layers 430 in FIG. 4A, and in FIG. 4B can be a continuous film formed from photosintering fluoroplastic particles (e.g., a continuous topcoat film formed according to the method 300 in FIG. 3). In an embodiment, the outermost layer 430 comprising a continuous film can be formed directly on the substrate surface (see FIG. 4A) or can be formed on a compliant layer 420, which may be a silicon rubber layer, that is formed on the substrate surface 410 (see FIG. 4B). For example, the fuser roll can be in a 2-layer configuration having a compliant layer 420, such as a silicone rubber layer having a thickness of, e.g., about 1 mm to about 5 mm, disposed between the coated outermost layer 430 and the core substrate 410, such as a metal used in the related art. In various embodiments, the coated outermost layer 430 can have a thickness of from about 5 microns to about 50 microns.

In an embodiment, a fuser such as fuser member 400B may additionally include a primer layer (not shown) disposed between the rubber compliant layer 420 and continuous topcoat film as an outermost layer 430. The primer layer may have a thickness of about 3 m to about 5 μm. In an embodiment, the outermost layer 430 of FIGS. 4A-4B is a continuous film that does not include the cracks and bubbles suffered by topcoat films formed according to conventional methods because outermost layer 430 is a continuous film formed of particles, such as PTFE and/or PFE particles, such as PTFE and/or PFE nanoparticles, which are exposed to pulsed light as described above with respect to method 300.

Photonic sintering (also referred to as photosintering or photonic curing) is a high-temperature thermal processing of using pulsed light from a flash lamp to form or manipulate films, such as thin films. In general photonic sintering has many advantages including a) high energy intensity—the use of photonic sintering to form continuous topcoat films as described above enables a process that achieve results faster and with fewer pulses. At peak power results can be achieved almost instantly without heating large volumes of space as is the case with radiant oven heating, b) low temperature—the use of photonic sintering to form continuous topcoat films as described above uses high energy pulsed light which has a very short duration (few us to few ms). High efficiency energy efficiency results from the high peak power that is focused on the target area; c) non-contact process—photonic sintering systems for forming continuous topcoat films as described above are relatively small, and such systems can be retrofitted on to an existing fuser manufacturing systems; d) high conversion efficiency—the use of photonic sintering to form continuous topcoat films as described above allows the use of low temperature substrates like paper or plastic that are not feasible with conventional Teflon coating techniques such as those in conventional TOS fuser roll manufacturing; e) scalable—the use of photonic sintering to form continuous topcoat films as described above allows for faster process speeds for higher and more economical throughput; f) broad spectrum light—the use of broad spectrum light in photonic sintering to form continuous topcoat films as described above allows for a wide variety of materials to be processed such as different nanoparticle systems/substrates to be processed with the same fuser member manufacturing system; and g) simple to implement and use—the use of photonic sintering to form continuous topcoat films as described above requires no scanning laser, no rolling plasma, and no oven.

Thus, in an embodiment, method 300 can be used to fabricate TOS fuser rolls and belts by using photonic sintering to cure PFA or even PTFE. The topcoat can be cured very rapidly with pulsed light from a flash lamp to mitigate the formation of crack and bubble defects. The pulsed high energy process allows for melting of PFA and/or PTFE nanoparticles to form a continuous film at relatively low temperature, at which the silicone degradation issues of conventional methods described above are mitigated. Therefore, the photonic sintering process disclosed herein, such as that described by method 300, benefits on widening process latitude, and improve productivity for TOS fuser manufacturing.

The primary advantages of sintering methods used with Teflon materials as described herein, such as method 300, are energy efficiency, cost savings, increased speed, and compatibility with a wider range of substrate materials. The photonic sintering process provides peak power that is more efficient at delivering useful energy. The high intensity also allows for deeper penetration through the thickness of the Teflon film. The use of short pulse durations on the order of milliseconds (versus ˜30 minutes in oven curing), as in the embodiments, provides for a process that is orders of magnitude faster than conventional heating methods, thereby saving time and energy. The high intensity pulse of light also produces minimal damage on low temperature substrates. This allows nanoparticles to be deposited and cured on a wide variety of low temperature substrates such as cloth, paper, and Mylar.

Two main parameters control the degree of sintering—the intensity of the lamp (volts) and the duration of the light pulse (microseconds). The flash lamp is typically held between 0.5 cm to 20 cm above the substrate, and an intense current is run through the flash lamp. Due to this intense current, the Xenon flash lamp issues a high intensity, broad spectrum pulse of light. This pulse of light is absorbed by the nanoparticles, which heats them to such a degree that the individual particles fuse together into a solid film. Because photonic sintering has a minimal effect on the substrate, it enables nanoparticle films to be cured on low temperature substrates such as paper, Mylar, polycarbonate, etc. In addition to allowing low temperature substrates to be used, the speed at which the films are sintered allows the use of inks which would oxidize if sintered over long periods of time using traditional methods (e.g. copper). The topcoat can be cured very rapidly with pulsed light from a flash lamp to mitigate the formation of crack and bubble defects. The high energy process allows melting PFA or PTFE nanoparticles to form a continuous film at relatively low temperature, thus mitigating substrate degradation. Therefore, the photonic sintering process benefits include compatibility with a wider range of substrate materials, energy savings, and improved productivity for PTFE film manufacture.

Sintering has been used to make objects from compressed powder heated below its melting point for minutes or hours depending on the material. Some current energy delivery methods used in sintering include oven heating, arc discharge, laser heating, and pulsed light. Pulsed light, or photonic sintering, is a low thermal exposure sintering method developed to sinter nanoparticle films. The process uses a xenon flash lamp to deliver a high intensity, short duration (<1 ms), pulse of light to the deposited nanoparticles. Photonic sintering was developed by Nanotechnologies (now NovaCentrix) of Austin, Tex., and was first made public in 2006. Photonic sintering is also known as pulsed thermal processing (PTP) and intense pulsed light (IPL) sintering.

### EXAMPLES

Initial experiments were carried out by fabricating and processing Teflon solutions on silicone substrates and subsequently photosintering them. Experiments were conducted to understand photonic sintering process parameters for use with Teflon nanoparticles, for example, with respect to the size of the nanoparticles, the choice of substrates, and the photonic curing parameter values (e.g. xenon lamp voltage, pulse duration, number of pulses, and pulse frequency) and effects on the quality of the resulting films. In some experiments, scanning electron microscope images may be used for determining the depth and amount of sintering that takes place for each experimental condition.

### Example 1

A metal core was coated with silicone conformable layer. A primer (990CL purchased from DuPont) layer of 3-5 μm is applied onto the roll by spray coating technique. The primed roll is preheated to 130° C. before applying topcoat. A topcoat coating formulation containing 200 nm PTFE particles is applied to a pre-heated roll by spray coating technique. The coated roll is dried for about 1 hour at less than 100 C to evaporate the solvent, then subject to photonic sintering with Xenon lamp (Pulseforge 3300). PTFE film is formed in a min. The operating voltage of the Xenon lamp 300 V, frequency was 1 Hz, pulse duration 1500 μs and number of pulses were varied from 3 pulses to 10 pulses.

### Example 2

The substrates used for the experiment were (1) Platinum cured silicone used in electrophotography (printer) fusers and (2) polyimide films. Teflon aqueous coating dispersion containing PTFE particles were acquired from DuPont. The dispersion was spray-coated onto the silicone substrates. For the polyimide substrates, a thin film of Teflon solution was coated using the draw bar coating method. Photonic sintering was carried out at Rochester Institute of Technology (RIT) using different process parameter values until qualitatively acceptable results were observed using pulse voltages in the 200-300V range and pulse durations in the 1.5-2.0 millisecond range.

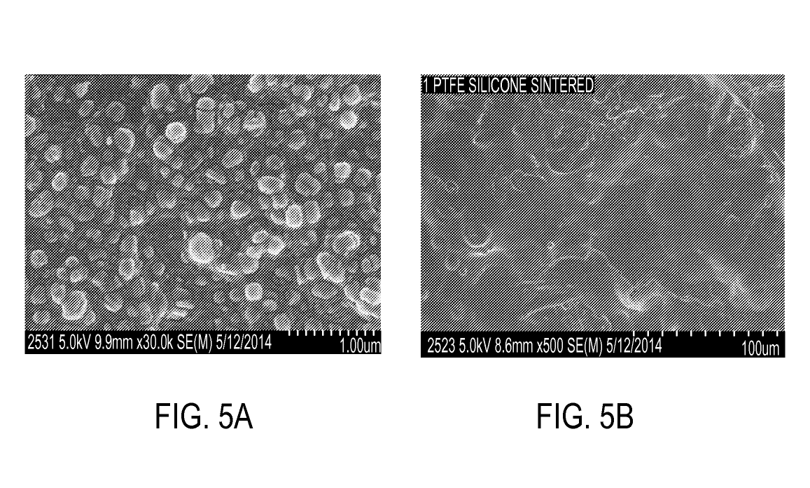

FIGS. 5A-5B are micrographs of the PTFE nanoparticles on silicone substrate before and after photonic sintering. Before sintering the individual PTFE particles are clearly visible (FIG. 5A). FIG. 5B shows the PTFE thin film formed after pulsed light sintering of the PTFE nanoparticles. As observed in FIG. 5B, the PTFE nanoparticles have fused together and begun to flow out into a smooth continuous film.

As determined from FIGS. 5A-5B, advantages of the pulsed light process described herein include: (a) it takes only milliseconds to complete versus ˜30 minutes in a radiant oven, and (b) there was no damage to the underlying silicone substrate. Additionally, conventional oven curing suffers from very low product yields due to formation of bubbles and cracks in the topcoat layer. In contrast, the method of exposing fluoroplastic particles to pulses of light as described herein results in continuous topcoat films that do not suffer from the bubbles and cracks of such conventionally made films.

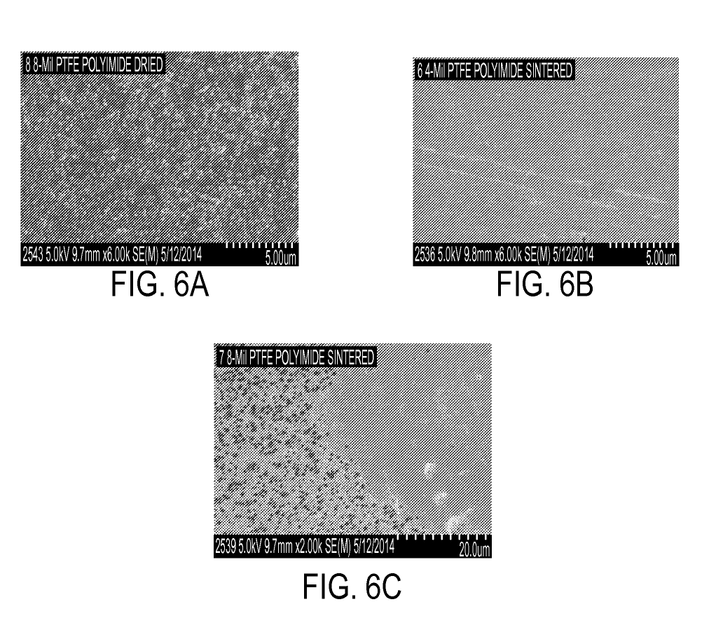

FIGS. 6A-6C are micrographs of PTFE nanoparticles on a polyimide substrate before (FIG. 6A) and after (FIG. 6B) sintering, with a side-by-side comparison (FIG. 6C) between the sintered and unsintered regions adjacent to one another on the polyimide substrate. The results are equally promising compared with results from the silicone substrate. As can be seen in FIG. 6A, individual PTFE nanoparticles can be observed on the polyimide substrate before sintering. On the other hand, a continuous PTFE film on the polyimide substrate is seen after the pulsed sintering (FIG. 6B). FIG. 6C shows the sintered and unsintered regions adjacent to one another on the polyimide substrate.

### Example 3

### Reduced Energy/Power Consumption

It is possible to use a power logging meter, such as a Fluke 1730, to measure actual power savings in using a photosintering process for curing Teflon nanoparticles to form continuous fluoroplastic topcoat films in fusing member manufacturing processes. Additionally, it is possible to calculate preliminary estimates of reduced energy/power consumption through numerical examples. For example, a cylindrical fuser roller with a 2.5 cm diameter and a length of 21.5 cm has a fuser surface area of π×D×L=169 cm². A Novacentrix PulseForge 3300 photonic curing system consumes 1.946 joules of energy per pulse when the pulse voltage and duration are 200V and 2.0 milliseconds respectively. In the case that 3 pulses are used to fully cure the surface area of the fuser, then the total energy consumed by the lamp for those 3 pulses is approximately:

$$\frac{{1.946}^{J} / {cm}^{2}}{pulse} \times 3 pulses \times 169 {cm}^{2} = 986 joules / roll .$$

By comparison the energy consumed by batch heating 100 fuser rolls at a time at 380° C. for 2 minutes in a 30,000 watt annealing oven would be approximately:

$$\frac{{30000}^{J} / sec \times 2 min \times 60 sec / min}{100 rolls} = 36 , 000 joules / roll .$$

Using these approximations, the heating energy applied with pulsed photonic curing is just:

986 joules/36000 joules×100%=2.7% of the energy applied using radiant oven curing.

Put another way, this represents an energy savings of 97.3%.

It is important to note that these estimates only factor in the energy used to heat the material. Other sub-system elements for both photonic curing and radiant oven curing consume energy as well. Thus, while not limited to any particular theory, it is anticipated that substantial energy savings will be realized. Accordingly, while some embodiments described herein focus on Teflon or TOS fuser rolls, the energy savings realized by practice of subject matter described herein can be extended to other applications for methods that produce products that include Teflon coatings.

### Example 4

### Improved Throughput and Product Quality

Fuser rollers, during manufacturing thereof, are fed into a pulsed photonic curing system, such as a system that performs a method of making a fuser roll, such as method 300 described above, at a very slow speed of just 10 ft/min. The system processes approximately 850 fuser rollers per hour. A fixture that holds an array of 10×10=100 fuser rollers at a time in a conventional curing oven heated to 380° C. for 30 minutes (that results in lower yields due to to the cracking/bubbling issues described above) permits just 200 rollers per hour to be processed per oven. Thus a throughput associated with pulsed photonic curing to form continuous topcoat films according to methods such as method 300 increase throughput as compared to conventional methods by at least a factor of four.

Photosintering methods for forming continuous fluoroplastic topcoat films, such as photosintering fluoroplastic particles, for example, according to method 300 described herein, provides defect-free PTFE surface coating in fuser rolls, which results a potential service life extension for fuser rolls. Improved product quality reduces energy consumption and material waste associated with production of reject parts.

While the present teachings have been illustrated with respect to one or more implementations, alterations and/or modifications may be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages may be added or existing structural components and/or processing stages may be removed or modified. Further, one or more of the acts depicted herein may be carried out in one or more separate acts and/or phases.

While embodiments disclosed herein are described with respect to methods of manufacturing fusion members of printer systems, the embodiments are not so limited. For example, photonic sintering can be used to produce Teflon coatings on high resolution print heads. Additionally, one major benefit of the pulsed light curing process (i.e., photonic sintering) is that it reduces high temperature curing limitations. Thus other applications, for example, those involving printed electronics, functional printing and 3D manufacturing can utilize such a method, such as, those that require formation of cured Teflon film can also benefit from the present embodiments. For example, specific examples of new products formed using cured Teflon films include the dielectric layer in printed thin film transistors, and the laminator layer in flexible solar cells. These processes often require low temperature substrates and high throughput roll to roll fabrication methods which are not generally compatible with batch oven processing. Additional embodiments of methods of manufacturing can be used to produce high temperature release films in the aerospace industry, as well as low friction films for biomedical devices such as prosthetics, and for ultrapure filtering membranes to name a few.

Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

As used herein, the phrase “one or more of”, for example, A, B, and C means any of the following: either A, B, or C alone; or combinations of two, such as A and B, B and C, and A and C; or combinations of three A, B and C.

Other embodiments of the embodiments will be apparent to those skilled in the art from consideration of the specification and practice of the embodiments disclosed herein. It is intended that the specification and examples be considered as exemplary only, with a true scope and spirit of the embodiments being indicated by the following claims.

What is claimed is:

1. A method of making fuser members, comprising:
applying a rubber conformance layer over a substrate;
applying a suspension composition over the rubber conformance layer, the suspension composition comprising a plurality of fluoroplastic particles; and
exposing the plurality of fluoroplastic particles to pulsed light to form a continuous topcoat film.

2. The method of claim 1, wherein the exposing to the pulsed light comprises photonic sintering for a time to sufficiently cure the plurality of fluoroplastic particles.

3. The method of claim 1, wherein the exposing the plurality of fluoroplastic particles to pulsed light comprises exposing the fluoroplastic particles to pulses of light from a xenon lamp, the pulses of the light lasting about 1 millisecond to about 2 milliseconds.

4. The method of claim 3, wherein the pulsed light is provided in pulses lasting about 1500 μs.

5. The method of claim 1, wherein the exposing the plurality of fluoroplastic particles to pulsed light is for a time to sufficiently melt at least some of the plurality of fluoroplastic particles.

6. The method of claim 1, wherein the exposing the plurality of fluoroplastic particles to pulsed light is for a time to sufficiently heat at least some of the plurality of fluoroplastic particles to a temperature of equal to or greater than a melting temperature of the fluoroplastic and lower than a degradation temperature of the rubber conformance layer.

7. The method of claim 1, wherein the continuous topcoat film is formed in about 1 minute or less.

8. The method of claim 1, wherein the pulsed light comprises from 1 to 20 pulses.

9. The method of claim 1, wherein the plurality of fluoroplastic particles comprises a plurality of fluoroplastic nanoparticles.

10. The method of claim 1, wherein the fluoroplastic particles comprise polytetrafluoroethylene (PTFE) nanoparticles.

11. The method of claim 1, wherein the fluoroplastic particles comprise perfluoroalkoxy polymer resin (PFA) nanoparticles.

12. The method of claim 1, further comprising applying a primer layer over the rubber conformance layer to form a primed member, wherein the primer layer is disposed between the rubber conformance layer and the topcoat film, and wherein the primer layer comprises a thickness of about 3 μm to about 5 μm.

13. The method of claim 12, wherein applying a primer layer comprises spray coating the primer.

14. The method of claim 12, further comprising preheating the primed member to a temperature below the degradation temperature of the rubber conformance layer.

15. The method of claim 1, further comprising sufficiently drying the suspension composition prior to the exposing the plurality of fluoroplastic particles to pulsed light.

16. The method of claim 1, wherein the topcoat film further comprises a filler.

17. The method of claim 1, wherein the suspension composition further comprises a filler.

18. A fuser member comprising:
a substrate;
a continuous topcoat film;
a silicone rubber layer disposed between the substrate and the continuous topcoat film; and
a primer layer disposed between the rubber layer and the continuous topcoat film,
wherein the continuous topcoat film comprises a cured fluoroplastic formed from photosintered nanoparticles.

19. The fuser member of claim 18, wherein the fuser member comprises a fuser roll or a fuser belt.

20. The fuser member of claim 18, wherein the continuous topcoat film further comprises a filler.
